(19) United States
(12) Patent Application Publication
(10) Pub. No.: US 2023/0000723 A1
(43) Pub. Date: Jan. 5, 2023

(54) Modular System and Method for Producing Dosage-Form Bulk Material

(71) Applicant: Glatt Ingenieurtechnik Gesellschaft mit beschränkter Haftung, Weimar (DE)

(72) Inventors: Andre Brudel, Weimar (DE); Anke Mothes, Weimar (DE)

(21) Appl. No.: 17/780,074

(22) PCT Filed: Nov. 17, 2020
(86) PCT No.: PCT/EP2020/082353

§ 371 Date: May 26, 2022

(30) Foreign Application Priority Data
Nov. 27, 2019 (DE) 10 2019 218 379.4

(51) Int. Cl. A61J 3/10; A61J 3/07; B30B 11/00

(52) U.S. Cl. CPC A61J 3/10; A61J 3/071; B30B 11/005

(57) ABSTRACT

A modular system for producing dosage-form bulk material in the form of dosage-form base materials or dosage forms. The system includes at least one processing unit (2) which includes a plurality of process stations, at least one container for receiving dosage-form bulk material, and at least one handling system, the at least one handling system transferring the containers between process stations. Also described is a method for producing dosage-form bulk material.

### CROSS-REFERENCE TO RELATED APPLICATIONS

This application is the United States national phase of International Application No. PCT/EP2020/082353 filed Nov. 17, 2020, and claims priority to German Patent Application No. 10 2019 218 379.4 filed Nov. 27, 2019, the disclosures of which are hereby incorporated by reference in their entirety.

### BACKGROUND

### Field

The invention relates to a modular system for the production of dosage-form bulk material in the form of dosage-form base materials or dosage forms, having at least one processing unit which comprises a plurality of process stations, at least one container for receiving dosage-form bulk material, and at least one handling system, wherein at least one handling system transfers the containers between process stations.

Furthermore, the invention relates to a method for the production of dosage-form bulk material in the form of dosage-form base materials or dosage forms, comprising a modular system with at least one processing unit which comprises a plurality of process stations, at least one container for receiving dosage-form bulk material, and at least one handling system, wherein at least one handling system transfers the containers between process stations.

### Description of Related Art

Modular systems and methods for the production of dosage-form bulk materials have long been known in the prior art. The prior art is presented below:

International patent application WO 2018/065081 discloses a method for the production of pharmaceutical tablets, in which tablet compacts are pressed and provided with a coating, wherein the tablet compacts are stored in an intermediate storage device for a product-specific curing time before they are provided with the coating, and thereafter are automatically removed from the intermediate storage device for further processing, wherein a system controller in which the product-specific curing times can be stored or are stored registers the time at which the tablet compacts are introduced into the intermediate storage device and, after the product-specific curing time has expired, initiates the automatic removal of the tablet compacts, and also discloses a system for producing pharmaceutical tablets, having at least one tablet press, having at least one coater which is downstream of the tablet press and which provides the tablet compacts formed in the tablet press with a coating, wherein the system has containers that are configured to receive the pressed tablets that are discharged from the tablet press, the system comprises an intermediate storage device with at least two storage locations, the system has a handling system that brings containers into the intermediate storage device and removes them from the intermediate storage device, and the system comprises a system controller which controls the handling system, wherein product-specific curing times can be stored or are stored in the system controller, and the system controller detects the contents of a container, the storage space assigned to a container in the intermediate storage device, and the start of the curing time and, after the curing time has elapsed, activates the handling system to remove the corresponding container from the intermediate storage device and convey it for further processing.

European patent EP 2 427166 B1 discloses a method for the production of tablets, and a module for the production of tablets which is suitable for carrying out the method, the module having at least one inlet for an active pharmaceutical ingredient, at least one inlet for an excipient, at least one mixing unit, a tablet press, and at least one discharge for tablets, wherein the inlets are in fluid communication with an inlet of the at least one mixing unit, a discharge of the at least one mixing unit is in fluid communication with an inlet of the tablet press, and a discharge of the tablet press is in fluid communication with the tablet discharge, characterised in that the module is enclosed, in that at least one analysis sensor is provided, the at least one analysis sensor being positioned to analyse the content or properties upstream of the tablet press, and in that the inlets comprise a detachable active pharmaceutical ingredient inlet line and a detachable excipient inlet line, and the discharge comprises a detachable tablet discharge port, such that the respective inlet lines and discharge port are generally closed, but—to allow for the insertion of the API and the excipients into the module and/or the removal of tablets from the module—can be opened, wherein the detachable inlet lines are in fluid communication with the inlet of the mixing unit, and the discharge of the tablet press is in fluid communication with the detachable tablet discharge port.

The technical solutions mentioned in the prior art for producing tablets have the disadvantage that they have long transfer times for the preparation of the dosage-form bulk material. In addition, in conventional manufacturing processes for dosage-form bulk materials, the individual handling processes between the process stations in the system are not connected, nor are they modular and correspondingly automated.

### SUMMARY

The object of the invention is therefore to provide both a modular system and a method for producing dosage-form bulk material comprising a modular system, wherein the transfer times of the dosage-form bulk material are shortened by the reduction of vertical and horizontal handling technology for the transport, and wherein the handling of dosage-form bulk material being processed is reduced.

This object is achieved with a modular system of the type mentioned at the outset in that, of the process stations, one process station is designed as a feed station, one process station is designed as a mixing or granulating station for carrying out a mixing process with regard to the dosage-form bulk material, and one process station is designed as a discharge station, and in that the modular system has an electronic system control device which controls each handling system, wherein process data for controlling each handling system can be stored or is stored in the system control device, which process data define a specific method for the production of dosage-form bulk material, wherein carrying out this method results in at least one container being moved between a plurality of process stations by means of at least one handling system. Individual pieces of equipment that work in batches are advantageously connected to each other by the modular system in such a way that the method carried out on the modular system runs fully automatically. As a result, a quasi-continuous process is thus provided.

A further advantage is that the handling system enables both horizontal and vertical transport, and/or both horizontal and vertical handling of the containers. The horizontal and/or vertical movement in this case can be carried out in particular as a movement that is executed sequentially, or as a movement that is superimposed in time.

The feed station is preferably designed as a container feed station, and/or as a container filling station. More preferably, the discharge station is designed as a container discharge station and/or as a container emptying station. Empty or already-filled containers are fed to the modular system in the container feed station, while empty or filled containers are removed from the modular system in the container discharge station. In the container filling station, an empty or already-filled container is filled with dosage-form bulk material, whereas a container filled with dosage-form bulk material is emptied in the container emptying station.

Pharmaceutical active ingredients and/or excipients are referred to as dosage-form bulk material. Dosage-form bulk material is usually in the form of a powder, granules, tablets, pellets, coated tablets, or capsules, in particular soft gelatine capsules or hard gelatine capsules.

According to an advantageous refinement of the modular system, the feed station and the discharge station are designed in the form of a structural unit as one process station. This further reduces the space requirement of the modular system.

The preferred modular system for producing dosage-form bulk material has the advantage that the at least one handling system reduces complex vertical and horizontal handling technology, on the one hand, and shortens transfer times between the basic operations which must run at the individual process stations, on the other hand. In addition, the investment and maintenance costs for the handling technology installed in the modular system, and for process equipment, as well as the associated supply systems, are reduced. Unmanned operation, i.e., fully automated operation, of the modular system is also feasible.

According to a preferred embodiment, the modular system has at least one processing unit, which has a process station designed as a container filling unit and/or a granulating station and/or a sieving station and/or a detection station for determining a quantity of the dosage-form bulk material based on the number of pieces or the weight thereof, and/or a drying station and/or an analysis station and/or a forming station and/or a sorting station and/or an inspection station and/or a control station and/or a storage station and/or a coating station and/or a tool changing station and/or a container cleaning station. The granulating station can also be designed as a mixing station, or can be designed as a structural unit together with the mixing station. The advantage in this regard is that various basic operations, such as granulating, drying, forming, weighing, mixing, etc., can be carried out with the modular system, and this means that both the modular system and the method for producing dosage-form bulk materials can be expanded and configured in a very flexible manner.

The at least one processing unit preferably has the process station designed as a container feed station and the process station which is suitable as a mixing station or granulating station for carrying out a mixing or granulation process with regard to the dosage-form bulk material. Such a configuration reduces the space taken up by the modular system, which is advantageous when converting existing systems, or building new systems. In addition, the modular system is designed as a very compact system, and the transfer times of the dosage-form bulk material during transport and handling are correspondingly shortened.

In this regard, the at least one processing unit advantageously has the process station designed as a forming station. The forming station can be, for example, a tablet press, a capsule filling station, or some other manner of filling station. The process of forming the dosage-form bulk material that is carried out in the forming station includes, for example, pressing tablets or filling capsules or filling pouches (bag filling) of the loose dosage-form bulk material.

According to an additional advantageous refinement of the modular system, the at least one processing unit has a plurality of handling systems. As a result, the modular system can be expanded as required, for example with a plurality of handling systems in one processing unit. Because the handling systems work in parallel, the process sequences can be divided between the individual handling systems and can therefore be optimised, for example with regard to the time required to carry out the process.

According to a preferred embodiment variant of the modular system, the at least one handling system is arranged in a central area of the processing unit, and the plurality of process stations is arranged around the central area. As a result, the space required for the modular system is reduced, and the media supply costs required therefor are reduced. In this regard, the plurality of process stations is preferably arranged in a substantially circular arc-shaped line around the central area. Such an arrangement of the plurality of process stations further reduces the space required, and thus reduces the media supply costs required therefor, and also shortens the transfer times and paths between the individual process stations.

According to a further advantageous refinement of the modular system, the modular system has a plurality of processing units. This makes it possible, for example, to assign a basic operation, such as mixing, granulating, forming, coating, etc., to the individual processing units of the modular system. Furthermore, it is possible to expand the modular system in almost any way.

In this regard, at least two processing units of the modular system form a pair of processing units, wherein the pair of processing units has a process station which can be assigned to each of the processing units forming the pair of processing units. This makes it possible to connect or interconnect processing units with each other.

In addition, the process station that can be assigned to each of the processing units forming the pair of processing units is preferably designed as a container transfer station, the same being designed as a container removal station for the processing unit delivering the container and as a container feed station for the processing unit receiving the container. Such a design of the modular system establishes a connection between the processing units by means of a process station designed as a container transfer station at which a container of one processing unit can be transferred to another processing unit.

Also preferably, a processing unit chain can be formed or is formed by at least two pairs of processing units.

In this regard, the at least one processing unit has a plurality of process stations designed as container filling stations. Due to this advantageous embodiment, the containers can be filled with different dosage-form bulk material.

According to an advantageous refinement of the modular system, at least one container and/or at least one process station comprises a normally closed connecting system, which can be opened or is opened for a dosage-form bulk material transfer. The connecting system is configured to connect, for example, two containers, or one container and a process station, with each other in such a way that during the transfer of dosage-form bulk material, the requirements for the degree of containment of the modular system during the filling or emptying of dosage-form bulk material into or out of the container and into or out of the process station are met. For example, absolutely reliable docking devices from the Glatt SKS or TKS containment valve system series can be used as the connecting system. The TKS containment valve system with two identical static seals guarantees a contamination-free dosage-form bulk material transfer. It enables dust-free product transfer even with substances with high OEL or OEB requirements, and also with requirements in the nanogram range. The intelligent valve technology ensures maximum safety for the product, people and the environment. The abbreviations OEL and OEB stand for “Occupational Exposure Band” and “Occupational Exposure Limit”, and provide information about the risk potential of a substance. The OEB value describes the toxicology of the pure dosage-form bulk material, while the OEL expresses the average exposure to the concentration of the active ingredient during an 8-hour shift for personnel.

The modular system has a degree of confinement below 5000 μg/m³, preferably below 1000 μg/m³, more preferably below 100 μg/m³, particularly preferably below 10 μg/m³, very particularly preferably below 1 μg/m³, and most preferably below 10 ng/m³. This serves to ensure the safety of dosage-form bulk material; the required degree of containment is advantageous for people and the environment. The SMEPAC test, for example, is used for the measurement, and the measurements are only carried out on each installed connecting system.

In addition, the modular system comprises a process station designed as a storage station, and has an electronic storage control device, wherein storage times specific to the dosage-form bulk material can be or are stored in the storage control device, the storage control device can record the start time of the storage of the at least one container filled with the dosage-form bulk material in the storage station, and, after the storage time has elapsed, can initiate the further processing of the at least one container filled with the dosage-form bulk material. By storing the dosage-form bulk material in the process station designed as a storage station, the dosage-form bulk material is stabilized during the storage period, such that the subsequent further processing can be carried out in an optimal manner. For example, dosage-form bulk material in the form of tablets has to harden, with the tablets growing or shrinking in their physical size. After the storage time which is specific to the dosage-form bulk material, in the storage station, a coating process can then be carried out in the coating station, for example, without the coating produced being adversely affected by the aforementioned expansion processes.

In this regard, the storage control device is designed as part of the system control device. This has the advantage that the investment costs can be reduced as a result.

According to an advantageous refinement of the modular system, at least one process station has a sensor, preferably an analytical sensor. The substance properties of the dosage-form bulk material can be determined in the processing station by means of the analytical sensor, for example. For example, an analytical sensor can analyse the homogeneity of the mixture in the process station designed as a mixing station.

In addition, the object is achieved with a method of the type mentioned at the outset, in that, of the process stations, one process station is designed as a feed station, one process station is designed as a mixing or granulating station for carrying out a mixing or granulating procedure with regard to the dosage-form bulk material, and one process station is designed as a removal station, and in that the modular system has an electronic system control device that controls each handling system, with process data for controlling each handling system being stored in the system control device, which process data define a specific method for the production of dosage-form bulk material, during the execution of which at least one container is moved by means of at least one handling system between a plurality of process stations.

According to a further preferred method, the modular system comprises a container filling station, the container being filled with dosage-form bulk material in the at least one container filling station.

The modular system preferably comprises a forming station, and the dosage-form bulk material located in the at least one container is mixed in the mixing station before it is formed in the forming station.

Advantageously, according to a refinement of the preferred method, the modular system comprises a dosage form coating station in which the dosage-form bulk material is coated.

According to an additional advantageous refinement of the method, the modular system includes a storage station in which the dosage-form bulk material is stored. In this regard, the storage station has a storage control device, wherein dosage-form-specific storage times are stored in the storage control device, and wherein the storage control device records the start time of storage of the at least one container filled with dosage-form bulk material and, after the storage time has elapsed, triggers the further processing of the at least one container filled with dosage-form bulk material. By storing the dosage-form bulk material in the process station designed as a storage station, the dosage-form bulk material is stabilized during the storage period, such that the subsequent further processing can be carried out in an optimal manner. For example, dosage-form bulk material in the form of tablets has to harden, with the tablets growing or shrinking in their physical size. After the storage time which is specific to the dosage-form bulk material, in the storage station, a coating process can then be carried out in the coating station, for example, without the coating produced being adversely affected by the aforementioned expansion processes.

Advantageously, the specific method for producing dosage-form bulk material is designed as a quasi-continuous or continuous method.

The modular system for carrying out the method is also advantageously designed as a modular system as described herein.

### BRIEF DESCRIPTION OF THE DRAWINGS

The invention is explained in more detail below with reference to the attached drawing. In the drawings:

FIG. 1 is a schematic representation of a first example of an embodiment of a modular system having a processing unit that has a plurality of process stations and a handling system,

FIG. 2 is a schematic representation of a second example of an embodiment of a modular system having a processing unit that has a plurality of process stations and a handling system,

FIG. 3 is a schematic representation of a third example of an embodiment of a modular system having a processing unit that has a plurality of process stations and a handling system,

FIG. 4 is a schematic representation of a fourth example of an embodiment of a modular system having a processing unit that has a plurality of process stations and a handling system,

FIG. 5 is a schematic representation of a fifth example of an embodiment of a modular system having a processing unit that has a plurality of process stations and two handling systems, and

FIG. 6 is a schematic representation of a sixth embodiment of a modular system having four processing units, each comprising a plurality of process stations and a handling system.

### DETAILED DESCRIPTION

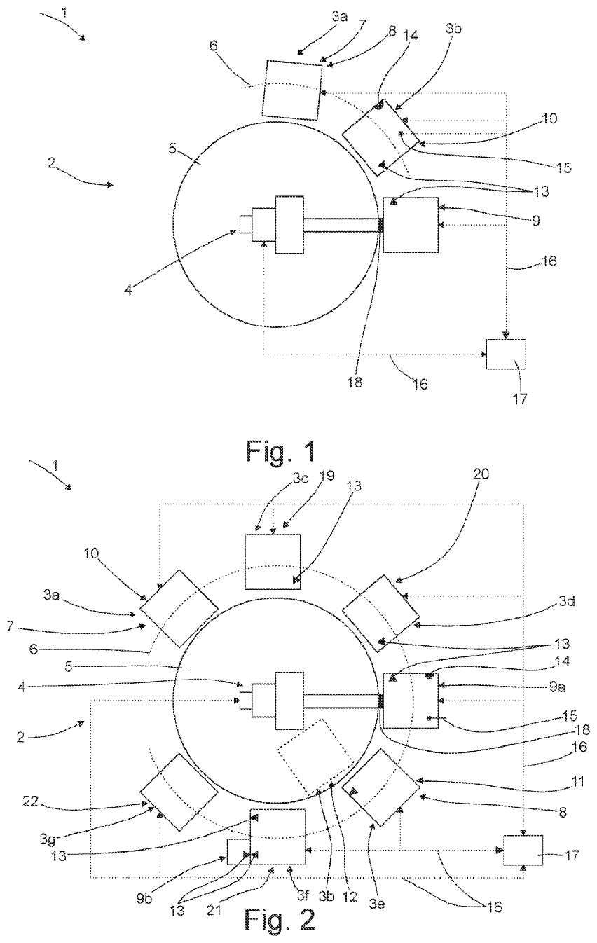

FIG. 1 shows a schematic representation of a first example of an embodiment of a modular system 1 for the production of dosage-form bulk material.

Pharmaceutical active ingredients and/or excipients are referred to as dosage-form bulk material, in the form of, for example, powder, granules, tablets, pills, coated tablets, oblongs or capsules, in particular soft gelatine capsules or hard gelatine capsules.

The active ingredients, some of which are highly potent, that are processed during the manufacture of dosage-form bulk materials, are harmful to human health and pollute the environment. To ensure safety for the dosage-form bulk material, people and the environment, the modular system 1 or its system components have a degree of confinement below 5000 μg/m³, preferably below 1000 μg/m³, more preferably below 100 μg/m³, particularly preferably below 10 μg/m³, very particularly preferably below 1 μg/m³, most preferably below 10 ng/m³, based on the dust emerging from the modular system 1, in particular the active ingredient dust.

The modular system 1 according to the first example of an embodiment comprises a processing unit 2 with two process stations 3 and a handling system 4.

The handling system 4 is arranged in a central area 5 of the processing unit 2, with the process stations 3 being arranged substantially on a circular arc-shaped line 6 around the central area 5. The handling system 4 enables both horizontal and vertical transport or both horizontal and vertical handling of the containers 9. The horizontal and/or vertical movement in this case can be carried out in particular as a movement that is executed sequentially, or as a movement that is superimposed in time.

In an embodiment that is not shown, the handling system is designed as an industrial robot arranged on a lifting column. As a result, a linear movement in the vertical direction can be carried out by the lifting column, which enables a simple, fast and yet very precise movement. The lifting column has a platform which can be rotated about a vertical lifting axis and on which the industrial robot is arranged. This makes it possible to move the industrial robot linearly in the vertical direction, and thus to arrange it in different height positions for the corresponding method steps and processes.

In an embodiment that is not shown, the industrial robot has a lifting column that performs a linear movement in the vertical direction, and/or a transport device, for example in the form of a carriage, that performs a linear movement in the horizontal direction.

The process station 3a is designed as a single unit with a feed station 7 and a discharge station 8 for a container 9 which is suitable for receiving dosage-form bulk material. In the first example of an embodiment, the feed station 7 is therefore referred to as the container feed station 10, and the discharge station 8 is referred to as the container discharge station 11. The process station 3b is designed as a mixing station 12 for carrying out a mixing procedure with respect to the dosage-form bulk material.

The container 9 and mixing station 12 each comprise a connecting system 13. The connecting system 13 is configured to connect two containers 9 or one container 9 and a process station 3b designed as a mixing station 12 with each other in such a way that the requirements for the degree of containment of the modular system 1 or its system components during a dosage-form bulk material transfer from the container 9 to the process station 3b designed as a mixing station 12, or vice versa, are met. The connecting system 13 is closed in the non-connected state and is opened in the connected, coupled state for dosage-form bulk material transfer. The connecting system 13 thus ensures that the people operating the modular system 1 are protected from exposure to dosage-form bulk material. Valve systems from the SKS or TKS valve series from Glatt GmbH, for example, are preferably used as the connecting system 13.

In addition, the mixing unit 12 has a sampling device 14. Dosage-form bulk material samples can be taken from the mixing unit 12 by means of the sampling device 14, and are then analysed with regard to their homogeneity, for example in a laboratory.

In addition, the mixing station 12 comprises a sensor 15, preferably an analytical sensor. The analytical sensor 15 is suitable for measuring the material properties of the dosage-form bulk material. For example, the humidity, the temperature, the formation of dust, the quantity or the fill level of the dosage-form bulk material is preferably detected by the analytical sensor 15. Furthermore, the individual process stations 3 can all be equipped with a sensor 15 or a plurality of sensors 15.

The material properties determined by the analytical sensor 15 are transmitted via a data transmission device 16 to an electronic system control device 17 of the modular system 1, where they are recorded and evaluated.

The electronic system control device 17 also controls the handling system 4 of the modular system 1, and also the process stations 3. For this purpose, process data for controlling the handling system 4 are stored in the system control device 17, which process data define a specific method for the manufacturing process of dosage-form bulk material. When the specific method is carried out, the container 9 is moved between the two process stations 3 by means of the handling system 4.

For example, an industrial robot suitable for a clean room is used as the handling system 4. It has a tool 18 for receiving the container 9. The tool 18 is adapted to the format—height and/or width and/or depth and/or shape—of the container 9.

The method for producing dosage-form bulk material carried out with the modular system 1 is as described below:

The container 9 filled with dosage-form bulk material is supplied to the feed station 7 designed as a container feed station 10 in the modular system 1. The feed station 7 connected to the system control device 17 via the data transmission device 16 transmits a signal to the system control device 17 that the container 9 has been provided in the feed station 7 for further processing.

The handling system 4 connected to the system control device 17 via the data transmission device 16 is actuated by the system control device 17 in order to pick up the container 9 and bring it to the mixing station 12. There, the container 9 is connected to the mixing station 12 via a connecting system 13, and the dosage-form bulk material contained in the container 9 is transferred to the mixing station 12 in accordance with the requirements for the degree of containment of the modular system 1.

The dosage-form bulk material is then mixed in the process station 3b designed as a mixing station 12. Using the sampling device 14 or the analytical sensor 15, it is possible to perform quality control of the mixture—offline, online or inline.

After the mixing process carried out in the mixing station 12, the mixed dosage-form bulk material is transferred from the mixing station 12 via the connecting system 13 back to the container 9.

The container 9 is picked up again by the handling system 4 and taken to the discharge station 8 designed as a container removal station 11, where the container 9 filled with the produced dosage-form bulk material is removed from the modular system 1.

FIG. 2 shows a schematic representation of a second example of an embodiment of a modular system 1 for the production of dosage-form bulk material.

In the second example of an embodiment, the modular system 1 has a processing unit 2 which comprises a plurality of process stations 3 and a handling system 4, in particular an industrial robot.

The handling system 4 is arranged in the central area 5 of the processing unit 2, with the process stations 3 being arranged substantially on the circular arc-shaped line 6 around the central area 5.

The processing unit 2 has seven process stations 3. These are arranged clockwise around the handling system 4, wherein the process station 3a is designed as a feed station 7, process station 3c is designed as a container filling station 19 for dosage-form bulk materials in the form of a basic medicinal product, for example an active ingredient, process station 3d is designed as a container filling station 20 for dosage-form bulk materials in the form of a basic medicinal product, for example an excipient, process station 3e is designed as a discharge station 8, process station 3b is designed as a mixing station 12, process station 3f is designed as a forming station 21, and process station 3g is designed as a tool changing station 22.

The feed station 7 forms a container feed station 10, and the discharge station 8 forms a container discharge station 11.

The container filling stations 19, 20 each comprise a connecting system 13 via which the dosage-form bulk material in the form of a dosage-form base substance—active ingredient or exciplent—can be transferred into the containers 9a, which can each be coupled to the container filling station 19, 20 and each have a connecting system 13.

The container 9a has a connecting system 13, a sampling device 14 and a sensor 15, in particular an analytical sensor which detects the material properties of the dosage-form bulk material, for example a humidity, temperature or level sensor. The sensor 15 arranged on the container 9a in the second example of an embodiment is designed as a level sensor. The individual process stations 3 can also all be equipped with a sensor 15 or a plurality of sensors 15 in order to better be able to monitor and control the process carried out.

The material properties determined by the analytical sensor 15 are transmitted via a radio-controlled or hard-wired data transmission device 16 to an electronic system control device 17 of the modular system 1, where they are recorded, evaluated and forwarded.

The electronic system control device 17 also controls the handling system 4 and the process stations 3 of the modular system 1. For this purpose, process data for controlling the handling system 4 are stored in the system control device 17, which process data define a specific method for the manufacturing process of dosage-form bulk material. When the specific method is carried out, the container 9 is moved between the seven process stations 3 by means of the handling system 4.

The process station 3b is designed as a mixing station 12 for carrying out a mixing process with respect to the dosage-form bulk material. In the second example of an embodiment, the container 9 is mixed in the state in which it is arranged on the handling system 4, wherein the mixing process takes place between the container filling station 20—after the container 9a has been filled with the dosage-form base materials—and the forming station 21.

The process station 3f is designed as a forming station 21, in particular a tablet pressing- or capsule filling system. The forming station 21 comprises two connecting systems 13, wherein the two connecting systems 13 have different formats for receiving different containers 9 in the second example of an embodiment.

The tool 18 arranged on the handling system 4 is interchangeable, such that the handling system 4 can, in particular, accommodate, or does accommodate, containers 9a, 9b that differ in their format. The tools 18 required to carry out the specific method are stored in the tool changing station 22.

For the safety of the product, people and the environment, the modular system 1 or its system components have a degree of confinement below 5000 μg/m³, preferably below 1000 μg/m³, more preferably below 100 μg/m³, particularly preferably below 10 μg/m³, very particularly preferably below 1 μg/m³, and most preferably below 10 ng/m³, based on the dust emerging from the modular system 1, in particular the active ingredient dust.

In the second example of an embodiment, the method for the production of dosage-form bulk material, which is carried out with the modular system 1, runs as described:

An empty container 9a is supplied to the process station 3a of the modular system 1, which is designed as a feed station 7 designed as a container feed station 10. The feed station 7, which is connected to the system control device 17 via the data transmission device 16, transmits a signal to the system control device 17 that the container 9a is ready for further processing.

The handling system 4, which is connected to the system control device 17 via the data transmission device 16, is actuated by the system control device 17 in order to pick up the container 9a and bring it to the process station 3c designed as a container filling station 19. There, the container 9a is connected via a connecting system 13 to the container filling station 19 which is designed, for example, as a screw dosing device, and is filled precisely with dosage-form bulk material in the form of a medicinal base substance designed as an active ingredient according to the specific method. For this purpose, the filling level is detected via the sensor 15, which is arranged in the container 9a and is designed as a filling level sensor. The filling level detected in the container 9a is transmitted to the system control device 17 via the data transmission device 16, where it is recorded and processed further.

The container 9a is then uncoupled from the container filling station 19 and brought to the container filling station 20 by means of the handling system 4. The container 9a is filled by the container filling station 20 via the connecting system 13 for filling with dosage-form bulk material in the form of an excipient. In this case, too, the fill level is detected via the sensor 15 embodied as a fill level sensor arranged in the container 9a, and transmitted to the system control device 17 via the data transmission device 16.

During the filling process of the container 9a at the container filling station 20, the handling system 4 changes the tool 18 at the tool changing station 22 in order to pick up another container 9b that is fed to the container feed station 10 and has a different format. The container 9b is then taken to the forming station 21 and connected there to the forming station 21 by a connecting system 13 corresponding to the format of the container 9b.

The handling system 4 then changes the tool 18 again at the tool changing station 22 in order to pick up the now filled container 9a at the container filling station 20. After being filled with dosage-form bulk material in the form of an excipient, the container 9a is uncoupled from the container filling station 20 and transported by the handling system 4 to the forming station 21. During the transfer to the forming station 21, the dosage-form bulk materials are mixed with each other in the container 9a, while the container 9a is arranged on the handling system 4 via the tool 18. Samples can be taken for quality control using the sampling device 14.

The container 9a is connected via the connecting system 13 to a connecting system 13 of the forming station 21 corresponding to the container format of the container 9a. In the second example of an embodiment, the forming station 211s designed as a tablet press. The mixed dosage-form bulk material contained in the container 9a is formed into dosage-form bulk material pressed into tablets by the forming station 21, and is conveyed into the container 9b. After being emptied into the forming station 21, the container 9a is brought to the container discharge station 11 by means of the handling system 4, and removed from the modular system 1 there. The container 9b containing the dosage-form bulk material produced in the form of tablets is then also brought to the container discharge station 11 by means of the handling system 4, and removed from the modular system 1 there. For this purpose, a tool change is carried out again in the tool changing station 22.

In order to increase efficiency, the process for producing dosage-form bulk materials can be controlled by the system control device 17 in such a way that dosage-form bulk materials are produced continuously in the forming station 21.

FIG. 3 shows a schematic representation of a third example of an embodiment of a modular system 1 for the production of dosage-form bulk material.

In the third example of an embodiment, the modular system 1 comprises a processing unit 2 which has a plurality of process stations 3 arranged substantially on the circular arc-shaped line 6 around the central area 5, and a handling system 4 arranged in the central area 5 of the processing unit 2.

The processing unit 2 has nine process stations 3, which may optionally have at least one connecting system 13. The process stations 3 are arranged clockwise around the handling system 4, wherein the process station 3a is designed as a feed station 7, and process station 3e is designed as a discharge station 8, process station 3c is designed as a container filling station 19, process station 3b is designed as a granulating station 23 for dosage-form bulk material that has already been premixed from dosage-form base materials—active ingredients and excipients, process station 3f is designed as a forming station 21, process station 3h is designed as a storage station 24, process station 3i is designed as a coating station 25, process station 3j is designed as a container cleaning station 26, process station 3g is designed as a tool changing station 22, and process station 3k is designed as a drying station 27.

The feed station 7 and discharge station 8 are designed as a single unit, with a container feed station 10 and a container discharge station 11, in a process station 3a,e.

In addition, the process station 3c forms a container filling station 19 for dosage-form bulk material that has already been premixed from active ingredient and excipient. The container filling station 19 comprises a connecting system 13 via which the dosage-form bulk material can be transferred to the container 9 connected to the container filling station 19.

The container 9 has a connecting system 13, a sampling device 14, and two sensors 15. The sensors 15 arranged on the container 9 in the third example of an embodiment are designed as a moisture sensor and a level sensor. The individual process stations 3 can all be equipped with a sensor 15 or a plurality of sensors 15, but are not equipped with anything in the present example of an embodiment.

The material properties of fill level and moisture of the dosage-form bulk material determined by the analytical sensors 15 are transmitted by radio transmission via a data transmission device 16 to an electronic system control device 17 of the modular system 1, where they are recorded and evaluated.

The electronic system control device 17 also controls the handling system 4 and the process stations 3 of the modular system 1. For this purpose, process data for controlling the handling system 4 are stored in the system control device 17; these data define a specific method for the manufacturing process for dosage-form bulk material. When the specific method is carried out, the container 9 is moved between the nine process stations 3 by means of the handling system 4.

The process station 3b is designed as a granulating station 23, such that the dosage-form bulk material is processed into granules in the granulating station 23. The granulating station 23 thus replaces the mixing station 12.

The process station 3f is designed as a forming station 21, in particular a tablet pressing- or capsule filling system. In the third embodiment, the forming station 21 is a capsule filling system.

The process station 3h is designed as a storage station 24, and comprises an electronic storage control device 28, wherein storage times specific to the dosage-form bulk material can be stored, or are stored, in the storage control device 28. The storage control device 28 can record the start time of the storage of the container 9 filled with dosage-form bulk material in the storage station 24, and after the storage time has elapsed, the further processing of the container 9 filled with dosage-form bulk material can be initiated. The storage control device 28 is designed as part of the system control device 17.

In the process station 3i designed as a coating station 25, the capsules are coated, for example with an enteric coating.

In addition, the modular system 1 comprises a process station 3j designed as a container cleaning station 26. There, the containers 9 can be cleaned without leaving any residue of dosage-form bulk material.

The tool 18 arranged on the handling system 4 can be exchanged, such that the handling system 4 can, in particular, accommodate, or does accommodate, containers 9 that differ in their format. The tools 18 required to carry out the specific method are stored in the process station 3g designed as a tool changing station 22.

Finally, the modular system 1 has a process station 3k designed as a drying station 27. The drying station 3k is in particular a fluidization apparatus, preferably a fluidized bed or spouted bed apparatus.

For the safety of the product, people and the environment, the modular system 1 or its system components have a degree of confinement below 5000 μg/m³, preferably below 1000 μg/m³, more preferably below 100 μg/m³, particularly preferably below 10 μg/m³, very particularly preferably below 1 μg/m³, and most preferably below 10 ng/m³, based on the dust emerging from the modular system 1, in particular the active ingredient dust.

In the third example of an embodiment, the method for the production of dosage-form bulk material, which is carried out with the modular system 1, runs as detailed below:

Containers 9 of different formats are supplied to the modular system 1 via the container feed station 10, and containers 9 are removed from the modular system 1 via the container discharge station 11.

The container filling station 19 fills the container 9a, which is connected to the container filling station 19 via a connecting system 13, and has a format. Two sensors 15 arranged in the container 9a transmit to the system control device 17 their recorded data relating to the moisture content of the dosage-form bulk material and the fill level of the container 9a.

The handling system 4 connected to the system control device 17 via the data transmission device 16 is actuated by the system control device 17 to bring the container 9a to the process station 3b designed as a granulating station 23. The container 9a is connected to the granulating station 23 via the connecting system 13, and the dosage-form bulk material is emptied into the granulating station 23, for example a high-shear granulator or a twin-screw extruder.

During the granulation process in the granulating station 23, the handling system 4 brings the container 9a to the container cleaning station 27, in which the container 9a is cleaned of dosage-form bulk material, leaving no residue. The container 9a is then connected again to the granulating station 23 by means of a connecting system 13 in order to receive the dosage-form bulk material in the form of granules. In particular, the moisture content of the granules is recorded by a sensor 15 and transmitted to the system control device 17, preferably for the purpose of controlling the drying station 27.

After being filled with dosage-form bulk material, the container 9a is uncoupled from the granulating station 23 and moved by the handling system 4 to the drying station 27, a fluidized bed apparatus. A sample can be taken for quality control via the sampling device 14 of the container 9a. The container 9a is emptied into the drying station 27 after being connected by means of the connecting system 13.

The dosage-form bulk material in the form of granules is dried in the drying station 27 in accordance with the method. For this purpose, the material properties, in particular the moisture content of the dosage-form bulk material in the form of granules, are continuously captured during the drying process and transmitted to the system control device 17.

During the drying process in the drying station 27, the container 9a is again cleaned, leaving no residue, in the container cleaning station 26, and is then connected to the drying station 27 via the connecting system 13 to receive the dry granules.

As soon as the drying in the drying station 27 is complete, the container 9a is filled and then taken to the forming station 21. A sample can be taken for quality control via the sampling device 14 of the container 9a. The forming station 21, in this case a capsule filling system, is filled with the dry dosage-form bulk material in the form of granules from the container 9a. The dosage-form bulk material in the form of granules is filled into capsules by the forming station 21.

During the filling process in the forming station 21, the handling system 4 changes the tool 18 at the process station 3g which is designed as a tool changing station 22, in order to pick up another container 9b that is supplied to the container feed station 10 and that has a different format. The container 9b is then taken to the forming station 21 and connected there to the forming station 21 by a connecting system 13 corresponding to the format of the container 9b.

The container 9a emptied in the forming station 21 is again cleaned without leaving any residue in the container cleaning station 26, and then brought back to the container filling station 19. The procedure described up to this point is repeated for the container 9a.

The container 9b connected to the forming station 21 receives the dosage-form bulk material produced in capsule form.

The container 9b filled with capsules is then taken to the storage station 24 and stored for a storage time which is specific to the dosage-form bulk material. For this purpose, the storage station 24 has a storage device equipped with a plurality of storage locations. The storage control device 28 in which the dosage form-specific storage times are saved, records the start time of the storage of the container 9b filled with dosage-form bulk material and, after the storage time has elapsed, initiates the removal of the container 9b from the storage station 24 for further processing of the container 9b filled with dosage-form bulk material. The storage times are particularly important for tablets, since they continue to change their size after the forming process in the forming station 21.

Following the storage station 24, a container 9b removed from the storage station 24 by the handling system 4 after its storage time is connected to the coating station 25, in particular a drum coater, by means of a connecting system 13 corresponding to the format of the container 9b.

In the coating station 25, the capsules are coated, for example with an enteric coating. During the coating process, the container 9b is cleaned, leaving no residue, in the container cleaning station 26 in order to then be connected to the coating station 25 to receive the coated capsules.

The container 9b filled with coated capsules is then brought to the container discharge station 11 by means of the handling system 4 in order to be removed from the modular system 1 there for further processing.

The procedure is then also repeated for the container 9b.

In order to increase efficiency, the process for producing dosage-form bulk materials can be controlled by the system control device 17 in such a way that a continuous process for producing dosage-form bulk material goods is achieved.

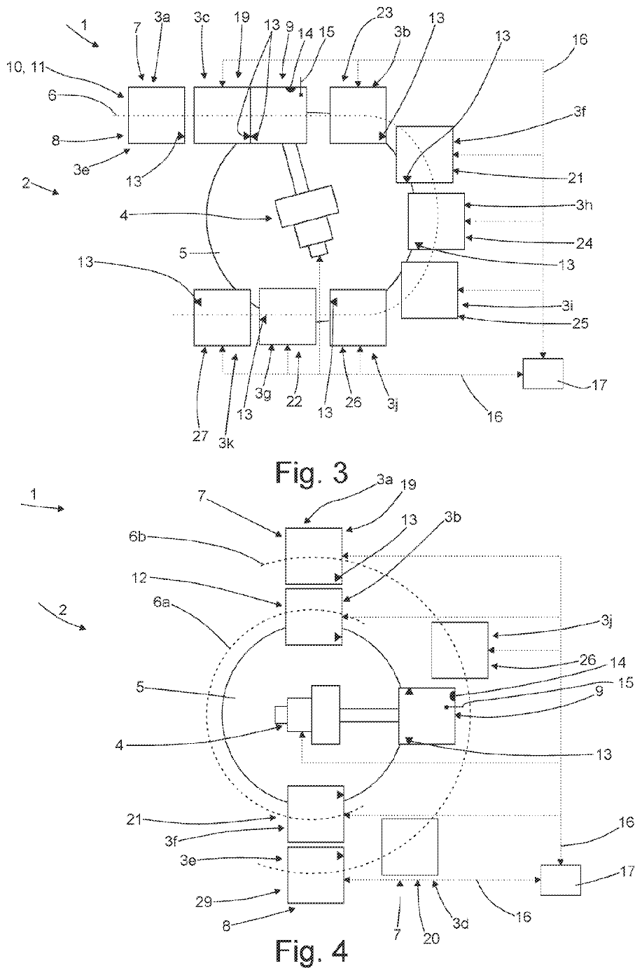

FIG. 4 is a schematic representation of a fourth example of an embodiment of a modular system 1 having a processing unit 2, which has six process stations 3 and a handling system 4, in particular an industrial robot.

The handling system 41s arranged in the central area 5 of the processing unit 2, with the process stations 3 being arranged substantially on two circular arc-shaped lines 6a and 6b running concentrically around the central area 5.

The process station 3c is designed as a feed station 7 in the form of a container filling unit 19 for dosage-form bulk material in the form of a pharmaceutical base material designed as an active ingredient, the process station 3d is designed as a container filling station 20 for dosage-form bulk material in the form of a pharmaceutical base material designed as an excipient, the process station 3e is designed as a discharge station 8 in the form of a container emptying station 29, the process station 3b is designed as a mixing station 12, the process station 3f is designed as a forming station 21, and the process station 3j is designed as a container cleaning station 26.

The feed station 7 forms a container filling station 19 and a container filling station 20.

The container filling stations 19, 20 each comprise a connecting system 13 via which the dosage-form bulk material in the form of a dosage-form base material designed as an active ingredient or excipient can be transferred into the container 9, which can be coupled to the container filling station 19, 20 and which has a connecting system 13.

The container 9 has a connecting system 13, a sampling device 14, and a sensor 15, in particular an analytical sensor which detects the material properties of the dosage-form bulk material—for example, a humidity, temperature, or level sensor. The sensor 15 arranged on the container 9 in the fourth example of an embodiment is designed as a level sensor. The individual process stations 3 can all be equipped with a sensor 15 or a plurality of sensors 15.

The material properties determined by the analytical sensor 15 are transmitted via a data transmission device 16, for example radio-controlled or hardwired, to an electronic system control device 17 of the modular system 1, where they are recorded and evaluated.

The electronic system control device 17 also controls the handling system 4 and the process stations 3 of the modular system 1. For this purpose, process data for controlling the handling system 4 are stored in the system control device 17, which process data define a specific method for the manufacturing process of dosage-form bulk material. When the specific method is carried out, the container 9 is moved between the seven process stations 3 by means of the handling system 4.

The process station 3b is designed as a mixing station 12 for carrying out a mixing process with respect to the dosage-form bulk material.

The process station 3f is designed as a forming station 21, in particular a tablet pressing- or capsule filling system. The forming station 21 comprises at least one connecting system 13.

For the safety of the product, people and the environment, the modular system 1 or its system components have a degree of confinement below 5000 μg/m³, preferably below 1000 μg/m³, more preferably below 100 μg/m³, particularly preferably below 10 μg/m³, very particularly preferably below 1 μg/m, and most preferably below 10 ng/m³, based on the dust emerging from the modular system 1, in particular the active ingredient dust.

In the second example of an embodiment, the method for producing dosage-form bulk material, which is carried out with the modular system 1, runs as described below:

The handling system 4, which is connected to the system control device 17 via the data transmission device 16, is actuated by the system control device 17 in order to bring the container 9 to the process station 3c designed as a container filling station 19. There, the container 9 is connected via the connecting system 13 to the container filling station 19 designed, for example, as a screw dosing device, and filled precisely according to the specific method with dosage-form bulk material in the form of a dosage-form base material designed as an active ingredient. For this purpose, the fill level is detected via the sensor 15 arranged in the container 9, which is designed as a fill level sensor. The fill level detected in the container 9 is transmitted via the data transmission device 16 to the system control device 17, where it is recorded and processed further.

The container 9 is then uncoupled from the container filling station 19, and brought to the container filling station 20 by means of the handling system 4. The container 9 is filled at the container filling station 20 via the connecting system 13 for filling with dosage-form bulk material in the form of a dosage-form base material designed as an excipient. In this case as well, the fill level is recorded by the sensor 15 which is arranged in the container 9 and which is configured as a fill level sensor, and is transmitted to the system control device 17 via the data transmission unit 16.

The container 9, which is filled with dosage-form base materials designed as active ingredients and excipients, is brought to the mixing station 12 by means of the handling system 9, and connected to it via the connecting system 13. The container 9 is then emptied into the mixing station 12. After the mixing process, the container 9 is filled with the mixed dosage-form bulk material.

The filled container 9 is then taken to the forming station 21, and there connected to the forming station 21 by a connecting system 13, and completely emptied into the forming station. In the fourth example of an embodiment, the forming station 21 is designed as a tablet press. The mixed dosage-form bulk material contained in the container 9 is transformed by the forming station 21 into dosage-form bulk material compressed into tablets.

During the forming process, the container 9 is moved by the handling system 4 to the process station 3j designed as a container cleaning station 26, where it is cleaned and then reconnected to the forming station 21 via the connecting system 13.

The dosage-form bulk material that has been formed into tablets is conveyed into the container 9. After being emptied into the forming station 21, the container 9 is brought to the container emptying station 29 by means of the handling system 4, and emptied there for further processing of the dosage-form bulk material in the form of tablets.

At the end of the method, the container 9 is cleaned again in the container cleaning station 26. The method can then be repeated.

The entire method is constantly monitored and controlled via the system control device 17.

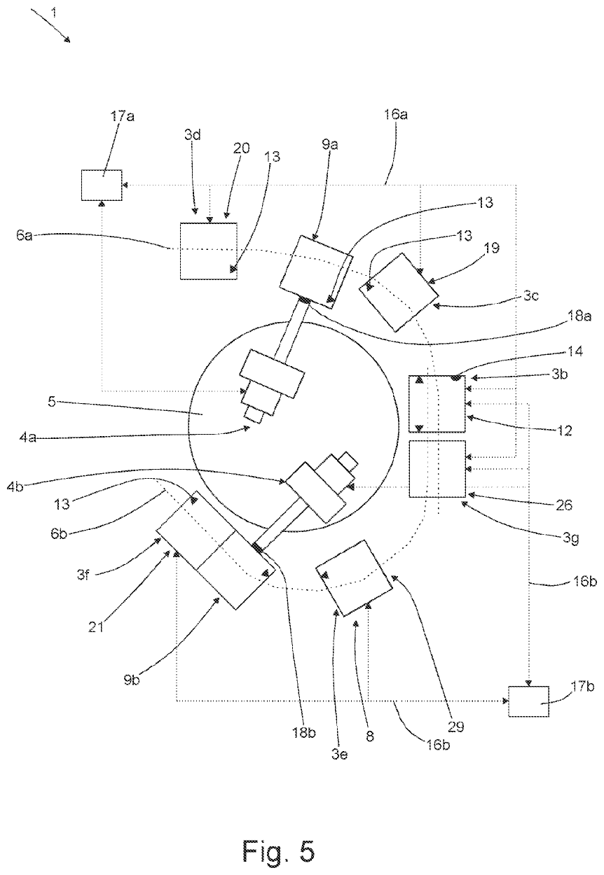

FIG. 5 is a schematic representation of a fifth example of an embodiment of a modular system 1 having a processing unit 2 that has a plurality of process stations 3 and, in contrast to the first four examples of embodiments, has two handling systems 4a and 4b in the central region S.

The handling system 4a moves a container 9a between the process station 3c designed as a container filling unit 19, the process station 3d designed as a container filling unit 20, the process station 3b designed as a mixing station 12, and the process station 3j designed as a container cleaning station 26.

The handling system 4b moves a container 9b between the process station 3b designed as a mixing station 12, the process station 3j designed as a container cleaning station 26, the process station 3f designed as a forming station 21, and the process station 3e designed as a container emptying station 29.

In addition, the modular system 12 has system control devices 17a and 17b. The system control device 17a is connected to the handling system 4a via a data transmission device 16a, and also to the process stations 3 that can be reached by the handling system 4a. The handling system 4b is connected to the system controller 17b and the process stations 3 that can be reached by the handling system 4b via a data transmission device 16b.

The handling systems 4a and 4b have tools 18a and 18b adapted to the formats of the containers 9a and 9b.

The modular system 1 for the production of dosage-form bulk material carries out a method according to the method sequence presented below.

The container 9a is connected to the handling system 4a by means of a tool 18a matched to the format of the container 4a, and is moved between the process stations 3 by the latter.

First, the container 9a is connected to the container filling unit 19 by means of the handling system 4a via the connecting system 13 and is filled with dosage-form bulk material in the form of a dosage-form bulk material designed as an active ingredient.

The container 9a is then uncoupled from the container filling unit 19 and brought to the container filling unit 20, connected to it via the connecting system 13, and filled with dosage-form bulk material in the form of a dosage-form base material designed as an excipient.

The container 9a filled with dosage-form bulk material is then brought by the handling system 4a to the mixing station 12, and emptied into it via the connecting system 13. In the mixing station 12, the dosage-form bulk material is mixed, in particular homogeneously. A sampling device 14 enables quality control.

In the process station 3j designed as a container cleaning station 26, the container 9a is cleaned before being refilled at the container filling station 19, 20.

The container 9b is connected to the handling system 4b by means of a tool 18b matched to the format of the container 4b, and is moved between the process stations 3 by the latter.

First, the container 9b is connected to the mixing unit 12 by means of the handling system 4b via the connecting system 13, and the mixed dosage-form bulk material is emptied into the container 9b.

The container 9b is then taken to the forming station 21 by the handling system 4b and completely emptied into it. Thereafter, the container 9b is brought to the container cleaning station 26 by the handling system 4b, where it is cleaned and brought back to the forming station 21.

The container 9b, which is connected to the forming station 21 via the connecting system 13, is now filled with the dosage-form bulk material formed in the forming station 21. After the container 9b has been uncoupled from the forming station 21, the container 9b is taken by the handling system 4b to the process station 3e, which is designed as a container emptying station 29, and is emptied there.

At the end of the method, the container 9b is cleaned again in the container cleaning station 26.

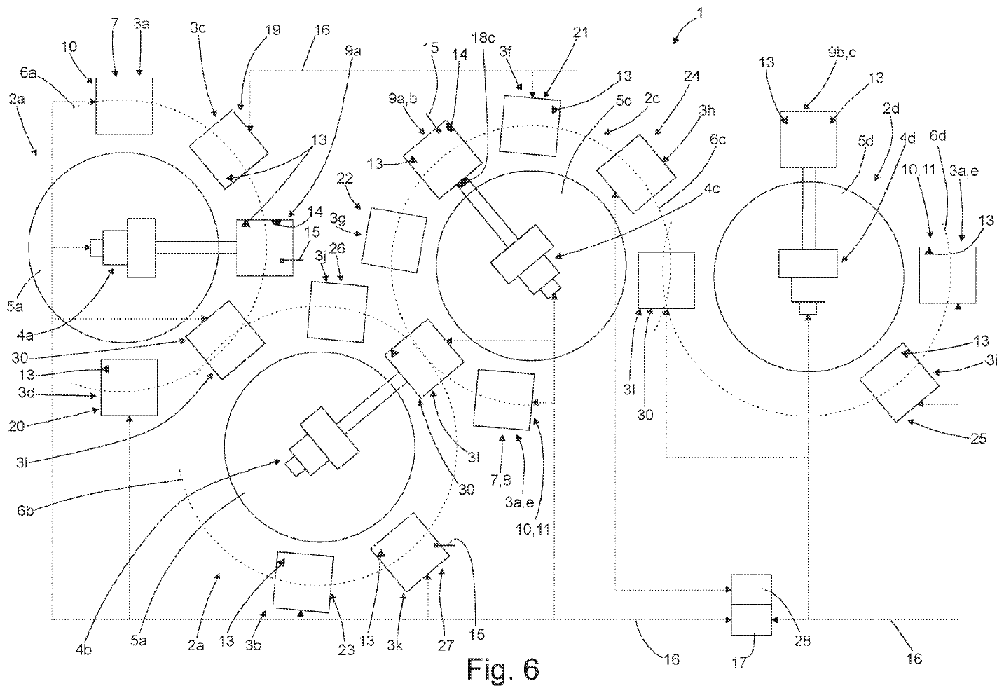

FIG. 6 is a schematic representation of a sixth example of an embodiment of a modular system 1 having four processing units 2, each of which comprises a plurality of process stations 3 and one handling system 4.

All handling systems 4 and all process stations 3 are connected to the system control device 17 via a data transmission device 16. The modular system 1 has an electronic system control device 17 that controls each handling system 4, wherein process data for controlling each of the handling systems 4 and the process stations 3 can be stored, or is stored, in the system control device 17, which process data define a specific method for the production of dosage-form bulk material. When this method is carried out, at least one container 9 is moved between a plurality of process stations 2 by means of at least one handling system 4.

The first processing unit 2a has a handling system 4a arranged in a central area 5a, with a plurality of process stations 3 being arranged on a substantially circular arc-shaped line 6a around the central area 5a.

The processing unit 2a has four process stations 3, which may optionally have at least one connecting system 13. The process stations 3 are arranged clockwise around the handling system 4a, wherein process station 3a is designed as a feed station 7, process station 3c is designed as a container filling station 19 for dosage-form bulk material in the form of dosage-form base material designed as an active ingredient, process station 3d is designed as a container filling station 20 for dosage-form bulk material in the form of dosage-form base material designed as an exciplent, and process station 3l is designed as a container transfer station 30.

The feed station 7 forms a container feed station 10.

The container filling stations 19, 20 each comprise a connecting system 13 via which the dosage-form bulk material in the form of a dosage-form base material designed as an active ingredient or excipient can be transferred, or is transferred, into the container 9a, which can be coupled to the container filling station 19, 20 and which has a connecting system 13.

The container 9a has a connecting system 13, a sampling device 14 and a sensor 15, in particular an analytical sensor which detects the material properties of the dosage-form bulk material, for example a humidity, temperature or level sensor. The sensor 15 arranged on the container 9a in the sixth example of an embodiment is designed as a level sensor. The individual process stations 3 can all be equipped with a sensor 15 or with a plurality of sensors 15.

The material properties determined by the analytical sensor 15 are transmitted via a data transmission device 16, for example radio-controlled or hardwired, to an electronic system control device 17 of the modular system 1, where they are recorded and evaluated.

The electronic system control device 17 also controls the handling system 4a and the process stations 3 of the modular system 1. For this purpose, process data for controlling the handling system 4a and the process stations 3 are stored in the system control device 17, which process data define a specific method for the manufacturing process of dosage-form bulk material. When the specific method is carried out, the container 9a can be moved between the four process stations 3 by means of the handling system 4a.

The second processing unit 2b has a handling system 4b arranged in a central area 5b, with a plurality of process stations 3 arranged on a substantially circular arc-shaped line 6b around the central area 5b.

The processing unit 2b has five process stations 3, which may optionally have at least one connecting system 13. The process stations 3 are arranged clockwise around the handling system 4b, wherein the process station 3l is designed as a container transfer station 30, process station 3j is designed as a container cleaning station 26, a further process station 3l is designed as a container transfer station 30, process station 3k is designed as a drying station 27 for dosage-form bulk material, and process station 3b is designed as a granulating station 23. The granulating station 23 in this case replaces the mixing station 12.

The container transfer stations 30 transfer the container 9a between the processing units 2a and 2b, and between the processing units 2b and 2c. Both processing units 2a and 2b, as well as 2b and 2c, form a pair of processing units 31 and a processing unit chain 32.

The container 9a can be cleaned in the container cleaning station 26.

The granulating station 23 granulates the dosage-form bulk material, and the drying station 27 dries the moist granules. The drying station 27 has a sensor 15 designed as a moisture sensor.

The individual process stations 3 can all be equipped with a sensor 15 or a plurality of sensors 15, and can also be partially equipped.

The electronic system control device 17 also controls the handling system 4b and the process stations 3 of the modular system 1. For this purpose, process data for controlling the handling system 4b and the process stations 3 are stored in the system control device 17, which process data define a specific method for the manufacturing process of dosage-form bulk material. When the specific method is carried out, the container 9a can be moved between the five process stations 3 by means of the handling system 4b.

The third processing unit 2c has a handling system 4c arranged in a central area 5c, with a plurality of process stations 3 arranged on a substantially circular arc-shaped line 6c around the central area 5c.

The processing unit 2c has six process stations 3, which may optionally have at least one connecting system 13. The process stations 3 are arranged clockwise around the handling system 4c. The process station 3a, 3e is designed as a structural unit, as a feed station 7 and discharge station 8, the feed station 7 being a container feed station 10 and the discharge station 8 being a container discharge station 11.

The process station 3l is designed as a container transfer station 30, process station 3g is designed as a container cleaning station 22c, process station 3f is designed as a forming station 21 for dosage-form bulk materials, process station 3h is designed as a storage station 24, and a further process station 3l is designed as a container transfer station 30.

The container transfer stations 30 transfer the container 9a between the processing units 2b and 2c, and the container 9b between the processing units 2c and 2d.

The forming station 21, in this case a tablet press, compresses the dosage-form bulk material into tablets, which are stored in the storage station 24 for a storage period. The modular system 1 has an electronic storage control device 28, wherein storage times specific to the dosage-form bulk material can be stored, or are stored, in the storage control device 28, and the storage control device 28 can record or does record the start time of the storage of the container 9b filled with dosage-form bulk material in the storage station 24, and, after the storage time has elapsed, can initiate or does initiate the further processing of the container 9b filled with the dosage-form bulk material in the form of tablets. The storage control device 28 is designed as part of the system control device 17.

The process stations 3 and the handling system 4c are likewise controlled via the system control device 17.

The fourth processing unit 2d has a handling system 4d arranged in a central area 5d, wherein a plurality of process stations 3 is arranged on a substantially circular arc-shaped line 6d around the central area 5d.

The processing unit 2d has three process stations 3 with at least one connecting system 13. The process stations 3 are arranged anti-clockwise around the handling system 4d, wherein the process station 3l is designed as a container transfer station 30, process station 3a, 3e is designed as a container feed station, 10 and container discharge station 11, and process station 3i is designed as a coating station 25 for dosage-form bulk materials.

The container feed station 10 and the container discharge station 11 are suitable for bringing containers 9 into and out of the modular system 1.

In the process station 3i designed as a coating station 25, the capsules are coated, for example with an enteric coating.

The containers 9b, c have a connecting system 13, a sampling device 14, and a sensor 15, in particular an analytical sensor detecting the material properties of the dosage-form bulk material, for example, a humidity, temperature or level sensor. The sensor 15 arranged on the container 9c in the sixth example of an embodiment is designed as a level sensor. The individual process stations 3 can all be equipped with a sensor 15 or with a plurality of sensors 15.

The material properties determined by the analytical sensor 15 are transmitted via a data transmission device 16, for example radio-controlled or hardwired, to an electronic system control device 17 of the modular system 1, where they are recorded and evaluated.

The electronic system control device 17 also controls the handling system 4d and the corresponding associated process stations 3 of the modular system 1. For this purpose, process data for controlling the handling system 4d and the corresponding associated process stations 3 are stored in the system control device 17, which process data define a specific method for the manufacturing process of dosage-form bulk material. When the specific method is carried out, the container 9d can be transported between the four process stations 3 by means of the handling system 4d.

The method for producing dosage-form bulk material according to the sixth example of an embodiment corresponds to the method sequence detailed below:

First, a container 9a is supplied to the modular system 1 via the container feed station 10, and is received by the handling system 4a.

The container 9a is then moved between the process stations 3 that can be reached by the handling system 4a, the container 9a being filled with an active ingredient in the container filling station 19 and with an excipient in the container filling station 20. For filling at the respective container filling station, 19, 20, the container 9a is connected to the container filling station 19, 20 in each case via a connecting system 13. As a result, the level of confinement required for the modular system 1 is maintained during filling. The fill quantity is recorded by the sensor 15, which is designed as a fill level sensor, and controlled by the system control device 17.

After the container 9a has been filled with dosage-form bulk material, it is transferred to the container transfer station 30 between the processing unit 2a and the processing unit 2b. The two processing units 2a and 2b of the modular system 1 form a pair of processing units 31ab, wherein the pair of processing units 31ab has the container transfer station 30, which can be assigned to each of the processing units 2a and 2b forming the pair of processing units 31ab.

The container 9a is then received by the handling system 4b in the processing unit 2b, and moved to the granulating station 23. The container 9a is coupled to the granulating station 23 via the connecting system 13, and the dosage-form bulk material is emptied into the granulating station 23.

During the granulation process, the container 9a is brought to the container cleaning station 26 with the handling system 4b, and cleaned there. The cleaned container 9a is now returned to the granulating station 23, connected thereto, and the dosage-form bulk material in granular form produced in the granulating station 23 is emptied into the container 9a. When the granulating station 23 is emptied, it is possible to interpose a screening station between the granulating station 21 and the container 9a, in order to even out the size of the dosage-form bulk material in the form of granules.

The moist granules contained in the container 9a are moved to the drying station 27 by means of the handling system 4b, and connected to it via the connecting system 13. The container 9a containing the dosage-form bulk material in the form of moist granules is then emptied into the drying station 27, preferably a fluidized bed or spouted bed apparatus, and dried there. During the drying process, the container 9a is brought to the container cleaning station 26 with the handling system 4b, and cleaned there. The cleaned container 9a is then brought back to the drying station 27, connected to it, and the dried granules are emptied into the container 9a.

The container 9a containing the dried granules is then taken to the container transfer station 30, which connects the processing units 4b and 4c to each other. The two processing units 2b and 2c of the modular system 1 form a pair of processing units 31bc, wherein the pair of processing units 31bc has the container transfer station 30, and can be assigned to each of the processing units 2b and 2c which form the pair of processing units 31bc.

The container 9a is then received by the handling system 4c in the processing unit 2c, and taken to the forming station 21. The container 9a is coupled to the forming station 21 via the connecting system 13, and the dried dosage-form bulk material in granular form is emptied into the forming station 21 designed as a tablet press.

During the filling process of the forming station 21, the handling system 4 changes the tool 18 at the process station 3g, which is designed as a tool changing station 22, in order to pick up another container 9b that is available at the container feed station 10 and has a different format.

The container 9b is then taken to the forming station 21 and connected there to the forming station 21 by a connecting system 13 corresponding to the format of the container 9b. The container 9b is then filled with dosage-form bulk material produced in the forming station 21 and designed as tablets.

After the container 9a has been emptied into the forming station 21, the container 9a is taken to the container discharge station 11 by means of the handling system 4c after another tool change, and is then ported out of the modular system 1.

After another tool change in the tool changing station 22, the container 9b is decoupled from the forming station 21 and brought to the storage station 24 with the handling system 4c, and stored for a storage time which is specific to the dosage-form bulk material. For this purpose, the storage station 24 has a storage device equipped with a plurality of storage locations. The storage control device 28 in which the dosage form-specific storage times are saved, records the start time of the storage of the container 9b filled with dosage-form bulk material and, after the storage time has elapsed, initiates the removal of the container 9b from the storage station 24 for further processing of the container 9b filled with dosage-form bulk material. The storage times are particularly important for tablets, because tablets require more time to establish and harden their dimensions after the forming process in the forming station 21.

After its storage time, the container 9b is removed from the storage station 24 by the handling system 4c and then brought to the container transfer station 30 between the processing units 2c and 2d. The two processing units 2c and 2d of the modular system 1 form a pair of processing units 31cd, the pair of processing units 31cd having the container transfer station 30 which can be assigned to each of the processing units 2c and 2d forming the pair of processing units 31cd.

The three pairs of processing units 31ab, 31bc and 31cd form a processing unit chain 32.

The handling system 4d picks up the container 9b filled with dosage-form bulk material in the form of tablets and brings it to the coating station 25, in particular a drum coater, where the container 9b is connected to the coating station 25 by means of a connecting system 13 corresponding to the format of the container 9b.

In the coating station 25, the dosage-form bulk material in the form of tablets is coated, for example with an enteric coating. During the coating process, the handling system 4d receives another container 9c corresponding to the format of the container 9b from the container feed station 10, and connects it to the coating station 25 for emptying the coated dosage-form bulk material.

While the container 9c is being filled at the coating station 25, the handling system 4d receives the container 9b, decouples it from the coating station 25, and takes it to the container discharge station 11 for removal from the modular system 1. The filled container 9c is then picked up by the handling system 4b and also taken to the container discharge station 11 for removal from the modular system 1.

In order to increase efficiency, the method for producing dosage-form bulk materials can be controlled by the system control device 17 in such a way that a continuous process for producing dosage-form bulk material goods is achieved.

1. A modular system for the production of dosage-form bulk material in the form of dosage-form base materials or dosage forms, comprising:
at least one processing unit which has a plurality of process stations;
at least one container for receiving dosage-form bulk material; and
at least one handling system, wherein at least one handling system transfers the containers between process stations,
wherein, of the process stations, one process station is designed as a feed station, one process station is designed as a mixing or granulating station for carrying out a mixing or granulating procedure with regard to the dosage-form bulk material, and one process station is designed as a discharge station, and
wherein the modular system has an electronic system control device that controls each handling system, wherein process data for controlling each handling system can be stored, or are stored, in the system control device, which process data define a specific method for producing dosage-form bulk material, wherein, when the method is carried out, at least one container is moved between a plurality of process stations by means of at least one handling system.

2. The modular system according to claim 1, wherein the feed station is designed as a container feed station and/or as a container filling station.

3. The modular system according to claim 1, wherein the discharge station is designed as a container discharge station and/or as a container emptying station.

4. The modular system according to claim 1, wherein the feed station and the discharge station are designed in the form of a structural unit, as a process station.

5. The modular system according to claim 1, wherein at least one processing unit has a process station designed as a container filling station and/or designed as a screening station, and/or a detection station for determining a quantity, based on piece count or weight, of dosage-form bulk material, and/or a drying station, and/or an analysis station, and/or a forming station, and/or a sorting station, and/or an inspection station, and/or a control station, and/or a storage station, and/or a coating station, and/or a tool changing station, and/or a container cleaning station.

6. The modular system according claim 1, wherein the at least one processing unit comprises the process station designed as a feed station, the process station which is suitable as a mixing station or granulating station for carrying out a mixing or granulating procedure with regard to the dosage-form bulk material, and the process station designed as a discharge station.

7. (canceled)

8. The modular system according to claim 1, wherein at least one processing unit comprises a plurality of handling systems.

9. The modular system according to claim 1, wherein the at least one handling system is arranged in a central area of the processing unit, and a plurality of process stations is arranged around the central area.

10. (canceled)

11. The modular system according to claim 1, wherein the modular system has a plurality of processing units.

12. The modular system according to claim 9, wherein at least two processing units of the modular system form a pair of processing units, the pair of processing units having a process station which can be assigned to each of the processing units which form the pair of processing units.

13. (canceled)

14. (canceled)

15. The modular system according to claim 1, wherein the modular system has a plurality of process stations designed as container filling stations.

16. The modular system according to claim 1, wherein at least one container and/or at least one process station comprises a normally closed connecting system which can be opened or is opened for the transfer of dosage-form bulk material.

17. (canceled)

18. The modular system according to claim 1, wherein the modular system comprises a process station designed as a storage station, and has an electronic storage control device, wherein storage times specific to the dosage-form bulk material can be stored or ae stored in the storage control device, the storage control device can record the start time of the storage of the at least one container filled with the dosage-form bulk material in the storage station, and, after the storage time has elapsed, can initiate the further processing of the at least one container filled with the dosage-form bulk material.

19. (canceled)

20. The modular system according to claim 1, wherein at least one process station has a sensor.

21. A method for producing dosage-form bulk material in the form of dosage-form base materials or dosage forms, comprising a modular system having at least one processing unit which has a plurality of process stations, at least one container for receiving dosage-form bulk material, and at least one handling system, wherein at least one handling system transfers the containers between process stations, wherein, of the process stations, one process station is designed as a feed station, one process station is designed as a mixing or granulating station for carrying out a mixing or granulating procedure with regard to the dosage-form bulk material, and one process station is designed as a discharge station, and in that the modular system has an electronic system control device which controls each handling system, wherein process data for controlling each of the handling systems are stored in the system control device, which process data define a specific method for producing dosage-form bulk material, wherein, when the method is carried out, at least one container is moved between a plurality of process stations by means of at least one handling system.

22. The method according to claim 21, wherein the modular system comprises a container filling station, the container being filled with dosage-form bulk material in the at least one container filling station.

23. The method according to claim 21, wherein the modular system comprises a forming station, and in that the dosage-form bulk material in the at least one container is mixed in the mixing station or granulated in the granulating station before it is formed in the forming station.

24. The method according to claim 21, wherein the modular system comprises a dosage-form coating station in which the dosage-form bulk material is coated.

25. The method according to claim 21, wherein the modular system comprises a storage station in which the dosage-form bulk material is stored and wherein the storage station has a storage control device, wherein dosage-form-specific storage times are stored in the storage control device, the storage control device records the start time of the storage of the at least a container filled with dosage-form bulk material, and, after the storage time has elapsed, initiates the further processing of the at least one container filled with dosage-form bulk material.

26. (canceled)

27. The method according to claim 21, wherein the specific method for producing dosage-form bulk material is designed as a quasi-continuous or continuous method.

28. The method according to claim 21, wherein the modular system for carrying out the method is designed as a modular system for the production of dosage-form bulk material in the form of dosage-form base materials or dosage forms, having at least one processing unit which has a plurality of process stations, at least one container for receiving dosage-form bulk material, and at least one handling system, wherein at least one handling system transfers the containers between process stations, wherein, of the process stations, one process station is designed as a feed station, one process station is designed as a mixing or granulating station for carrying out a mixing or granulating procedure with regard to the dosage-form bulk material, and one process station is designed as a discharge station, and in that the modular system has an electronic system control device that controls each handling system, wherein process data for controlling each handling system can be stored, or are stored in the system control device, which process data define a specific method for producing dosage-form bulk material, wherein, when the method is carried out, at least one container is moved between a plurality of process stations by means of at least one handling system.
